(19) United States
(12) Patent Application Publication
(10) Pub. No.: US 2012/0272188 A1
(43) Pub. Date: Oct. 25, 2012

(54) INFORMATION PROCESSING APPARATUS, INFORMATION PROCESSING METHOD, AND NON-TRANSITORY COMPUTER READABLE MEDIUM

(75) Inventors: Setsu KUNITAKE, Kanagawa (JP); Shigehisa KAWABE, Kanagawa (JP)

(73) Assignee: FUJI XEROX CO., LTD., Tokyo (JP)

(21) Appl. No.: 13/285,815

(22) Filed: Oct. 31, 2011

(30) Foreign Application Priority Data
Apr. 21, 2011 (JP) 2011-094906

(51) Int. Cl. G06F 3/048

(52) U.S. Cl. 715/811

(57) ABSTRACT

An information processing apparatus includes a registration unit and a setting unit. The registration unit registers in an operation history memory, when obtaining operator information indicating an operator who has performed an operation on a document, document identification information of the document and an operation history including the operator information in association with each other. The setting unit refers to a setting rule memory that stores a setting rule which is a predetermined rule for setting a usage limitation for the operation history and which associates a setting condition with usage limitation information, and, in a case where the operator information included in the operation history satisfies the setting condition, performs setting so that the usage limitation information associated with the satisfied setting condition is used for usage limitation of the operation history of the document identified by the document identification information associated with the registered operation history.

### CROSS-REFERENCE TO RELATED APPLICATIONS

This application is based on and claims priority under 35 USC 119 from Japanese Patent Application No. 2011-094906 filed Apr. 21, 2011.

### BACKGROUND

(i) Technical Field

The present invention relates to an information processing apparatus, an information processing method, and a non-transitory computer readable medium.

(ii) Related Art

Technologies for managing accesses to electronic information are available.

Also, technologies for managing history of operations performed on a document by attaching identification information to the document are available.

### SUMMARY

According to an aspect of the invention, there is provided an information processing apparatus including a registration unit and a setting unit. The registration unit registers in an operation history memory, when obtaining operator information indicating an operator who has performed an operation on a document, document identification information of the document and an operation history including the obtained operator information in association with each other. The setting unit refers to a setting rule memory that stores a setting rule which is a predetermined rule for setting a usage limitation for the operation history and which associates a setting condition with usage limitation information, the setting condition including a condition regarding the operator information, the usage limitation information indicating a set of an entity which uses the operation history and a usage form which is permitted or not permitted for the entity, and, in a case where the operator information included in the operation history registered by the registration unit satisfies the setting condition in the setting rule, performs setting so that the usage limitation information associated with the satisfied setting condition is used for usage limitation of the operation history of the document identified by the document identification information associated with the registered operation history.

### BRIEF DESCRIPTION OF THE DRAWINGS

Exemplary embodiments of the present invention will be described in detail based on the following figures, wherein:

FIG. 1 is a diagram illustrating an example of a schematic configuration of a system;

FIG. 2 is a block diagram illustrating an example of a schematic inner configuration of a management server;

FIG. 3 is a diagram illustrating an example of a structure of an organization;

FIG. 4 is a diagram illustrating an example of data content stored in an operation history DB;

FIG. 5 is a diagram illustrating an example of data content stored in a history access right setting rule DB;

FIG. 6 is a flowchart illustrating an example of a procedure of a process performed by the management server;

FIG. 7A is a diagram illustrating an example of data content stored in a history access right DB;

FIG. 7B is a diagram illustrating another example of data content stored in the history access right DB;

FIG. 8 is a diagram illustrating another example of data content stored in the operation history DB;

FIG. 9 is a diagram illustrating still another example of data content stored in the operation history DB;

FIG. 10 is a diagram illustrating another example of data content stored in the history access right setting rule DB;

FIG. 11A is a diagram illustrating still another example of data content stored in the history access right DB;

FIG. 11B is a diagram illustrating still another example of data content stored in the history access right DB;

FIG. 11C is a diagram illustrating still another example of data content stored in the history access right DB;

FIG. 11D is a diagram illustrating still another example of data content stored in the history access right DB;

FIG. 12 is a block diagram illustrating another example of the schematic inner configuration of the management server;

FIG. 13 is a diagram illustrating still another example of data content stored in the operation history DB;

FIG. 14 is a diagram illustrating an example of data content stored in a history access right deletion rule DB;

FIG. 15A is a diagram illustrating still another example of data content stored in the history access right DB;

FIG. 15B is a diagram illustrating still another example of data content stored in the history access right DB;

FIG. 15C is a diagram illustrating still another example of data content stored in the history access right DB;

FIG. 15D is a diagram illustrating still another example of data content stored in the history access right DB;

FIG. 16 is a block diagram illustrating still another example of the schematic inner configuration of the management server;

FIG. 17 is a diagram illustrating an example of data content stored in a history access right setting result DB;

FIG. 18 is a diagram illustrating another example of data content stored in the history access right setting result DB;

FIG. 19 is a flowchart illustrating an example of a procedure of a process performed by the management server; and

FIG. 20 is a diagram illustrating an example of a hardware configuration of a computer.

### DETAILED DESCRIPTION

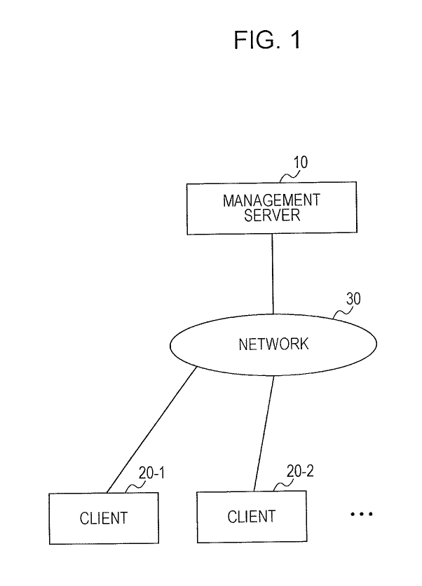

FIG. 1 illustrates an example of a schematic configuration of a system including an information processing apparatus according to various exemplary embodiments of the present invention. The system illustrated in FIG. 1 includes a management server 10 and clients 20-1, 20-2, . . . (hereinafter collectively referred to as “clients 20”) that are connected to one another via a network 30. The management server 10 manages information about users of the system and information about documents used in the system. The management server 10 functions as the information processing apparatus according to exemplary embodiments of the present invention. Each of the clients 20 is a terminal apparatus that is operated by a user of the system, and may be a typical information processing apparatus, such as a personal computer (PC). The network 30 is a communication medium, such as a local area network (LAN) or the Internet.

Hereinafter, various exemplary embodiments of the present invention will be described, particularly in regard to the case of managing documents used in jobs conducted in organizations, such as companies and public offices, using the system illustrated in FIG. 1. Examples of documents used in jobs include approval documents, applications, proposals, and reports. Plural operations may be performed on a document used in a job by one or more users related to the job as the job progresses. In the various exemplary embodiments described below, a paper document, which is generated by printing an electronic document on paper, is sequentially forwarded to one or more users, and operations regarding a job are performed on the paper document by the individual users. Hereinafter, a paper document forwarded to users in a job may be simply referred to as a “document”. A forwarded document has a document ID, which is identification information of the document, printed thereon together with the content of the document. The management server 10 manages pieces of information about individual documents using respective document IDs. A user who performs an operation on a paper document having a document ID printed thereon uses his/her client 20 to transmit the document ID of the document and information about the operation to the management server 10. Examples of information about an operation include the user ID of the user who performs the operation, the date/time when the operation was performed, and the type of operation. The management server 10 registers, in a database, an operation history including the information about the operation in association with the document ID received from the client 20.

A user who is involved in a job in which a document is used may want to check the operation history of the document. For example, a user may want to check the history of operations performed by other users on a document used for a job in order to recognize the progress of the job in which the user is involved. In such a case, it is demanded that the management server 10 has a function of providing an operation history registered in a database in response to a request from the client 20 of the user. However, the operation history of a document may include information the unauthorized use of which is to be prevented, such as personal information including a user ID. Also, the operation history of each document may include plural records, and thus the number of records may be much larger than the number of documents. Thus, it is appropriate to narrow down the records of an operation history registered in the database and to selectively provide the record(s) related to the user who has requested the operation history. For the reasons described above, it is appropriate to limit access to the operation history of a document.

In order to limit access to the operation history of a document, an access right may be set for the operation history of the document by applying the related art for setting an access right for each of electronic objects (a file of an electronic document, a folder that stores a file, etc.). However, as described above, the operation history of each document may include plural records, and thus a larger number of records than the number of documents may become targets for which an access right is to be set. If an access right is set for each record of the operation history of each document by applying the related art for setting an access right for each object, the load of the setting operation is larger than that in the case of setting an access right for each document.

Also, it may be demanded that an access right for a document itself be different from an access right for the operation history of the document. For example, a user who determines whether or not a specific operation has been performed on a certain document may not necessarily have a right to view the content of the document. In this case, it may be appropriate that an access right of not permitting viewing by the user be set for the document itself, and that an access right of permitting viewing by the user be set for the operation history of the document. In some cases, it is not necessary for a user who has the right to view the content of a certain document to view the operation history of the document. In this case, it is appropriate to set an access right of not permitting viewing of the operation history for a user who does not have necessity of viewing the operation history.

In the various exemplary embodiments described below, the management server 10 sets an access right for accessing the operation history of a document in accordance with a rule that is preset regarding the operation history when recording the operation history of the document. The management server 10 sets and manages an access right for accessing the operation history of a document separately from an access right for accessing the document itself.

### First Exemplary Embodiment

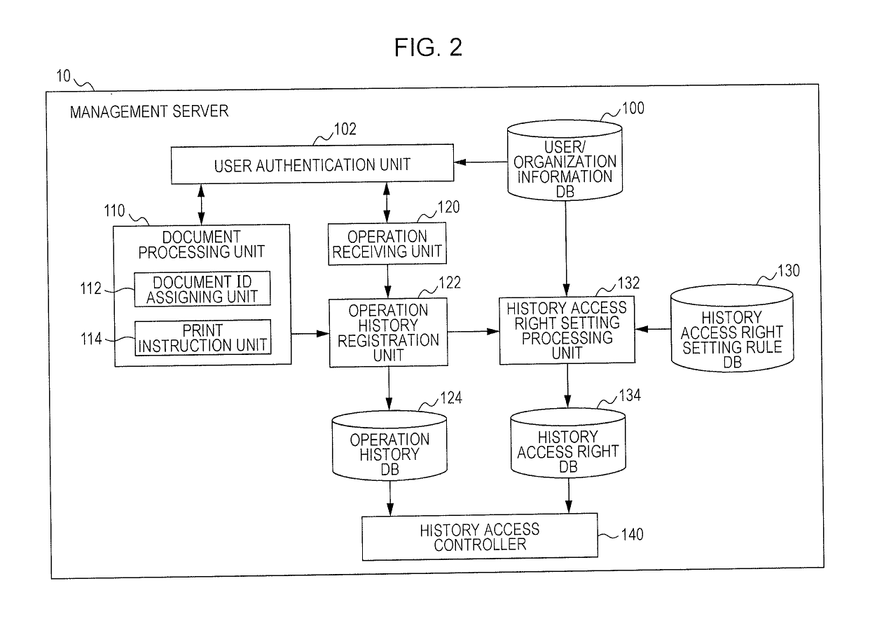

FIG. 2 is a block diagram illustrating an example of a schematic inner configuration of the management server 10 according to a first exemplary embodiment. The management server 10 illustrated in FIG. 2 includes a user/organization information database (DB) 100, a user authentication unit 102, a document processing unit 110, an operation receiving unit 120, an operation history registration unit 122, an operation history DB 124, a history access right setting rule DB 130, a history access right setting processing unit 132, a history access right DB 134, and a history access controller 140.

The user/organization information DB 100 is a database that stores information about users and an organization that use the system illustrated in FIG. 1. The user/organization information DB 100 stores, for example, user IDs serving as pieces of identification information of individual users, and pieces of authentication information (passwords) of the individual users. The user/organization information DB 100 further stores information about an organization that uses the system. The information about an organization includes, for example, identification information of user groups constituting the organization (departments, sections, groups, teams, etc.), information representing the hierarchical structure of the organization constituted by the user groups, user IDs of users who belong to the individual user groups, and user IDs of users who play specific roles in the organization.

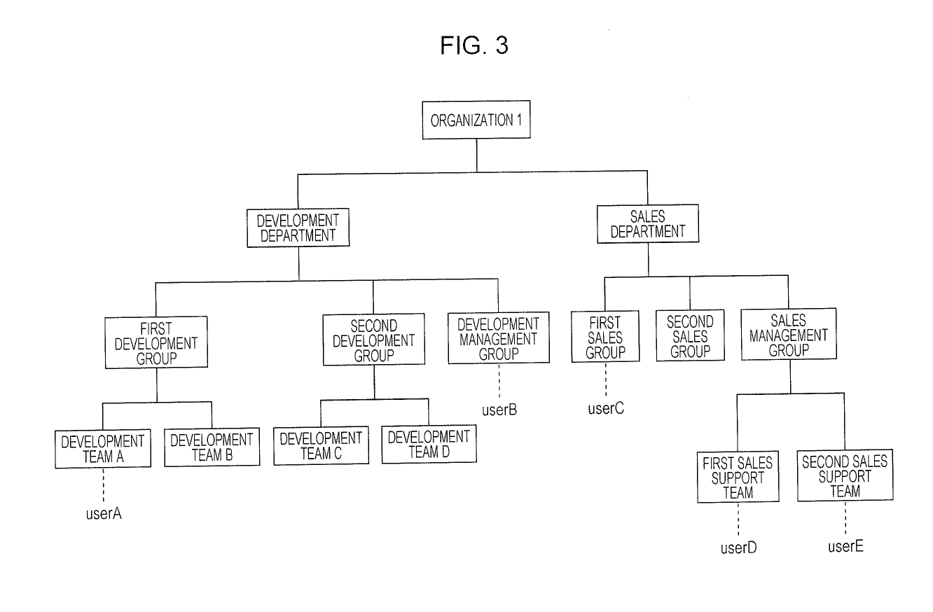

A specific example of information about an organization will be described with reference to FIG. 3. FIG. 3 is a diagram schematically illustrating an example of the configuration of part of “organization 1” that uses the system. “Organization 1” illustrated in FIG. 3 includes departments, such as “development department” and “sales department”. In FIG. 3, character strings shown in individual boxes represent the names of the respective user groups. Regarding the configuration illustrated in FIG. 3, identification information of the individual user groups (“development department”, “sales department”, “first development group”, “second development group”, etc.) is stored in the user/organization information DB 100. As the information representing the hierarchical structure of the organization constituted by these user groups, information indicating that “first development group”, “second development group”, and “development management group” exist as user groups included in “development department” is stored in the user/organization information DB 100. Furthermore, information indicating that “development team A” and “development team B” exist as user groups included in “first development group”, and information indicating that “development team C” and “development team D” exist as user groups included in “second development group” are stored in the user/organization information DB 100. Regarding the department “sales department”, information indicating that “first sales group”, “second sales group”, and “sales management group” exist as the user groups included therein, and information indicating that “first sales support team” and “second sales support team” exist as the user groups included therein are stored in the user/organization information DB 100. Also, for example, “userA”, “userB”, “userC”, “userD”, and “userE” are stored in the user/organization information DB 100 as the user IDs of users who belong to “development team A”, “development management group”, “first sales group”, “first sales support team”, and “second sales support team”, respectively. Also, user IDs that are not illustrated in FIG. 3 may be stored in the user/organization information DB 100 as the user IDs of users who belong to the individual user groups illustrated in FIG. 3. Furthermore, the user IDs of users who are leaders of the individual user groups in the organization illustrated in FIG. 3 (manager, group leader, team leader, etc.) may be stored in the user/organization information DB 100.

Referring back to FIG. 2, the user authentication unit 102 authenticates, when receiving a request for using individual functions of the management server 10 (described below), the user who has transmitted the request. For example, the user authentication unit 102 receives the user ID and password of the user who has transmitted the request, and determines whether or not the set of the received user ID and password matches a set of a user ID and password registered in the user/organization information DB 100, thereby performing user authentication. Only if the user authentication unit 102 succeeds in authentication, the user who has transmitted the request is permitted to use the individual functions of the management server 10 (described below).

The document processing unit 110 performs processing related to a document managed by the management server 10. The document processing unit 110 according to the first exemplary embodiment performs processing for causing a printer (not illustrated) to output a paper document that has a document ID of an electronic document to be printed and the content of the electronic document printed thereon in response to a request for printing the electronic document from the client 20. The document processing unit 110 includes a document ID assigning unit 112 and a print instruction unit 114.

The document ID assigning unit 112 assigns a document ID to a document. The document ID may be identification information that is unique in the documents managed by the management server 10. In the first exemplary embodiment, when the management server 10 receives a request for printing an electronic document from the client 20, the document ID assigning unit 112 generates a new document ID and assigns the document ID to the electronic document to be printed. The document ID assigning unit 112 supplies the document ID assigned to the electronic document to be printed to the print instruction unit 114.

The print instruction unit 114 instructs the printer to print the electronic document to be printed and the document ID assigned to the electronic document by the document ID assigning unit 112 onto paper. At this time, the print instruction unit 114 instructs the printer to print the document ID by converting it into a machine-readable code. Examples of the code representing the document ID include a one-dimensional code such as a bar code, and a two-dimensional code such as a quick response (QR) code. Alternatively, instead of providing an instruction to print a code representing a document ID on paper, the print instruction unit 114 may instruct the printer to print a character string (including at least one of characters, numerals, and symbols) representing a document ID on paper using a font suitable for optical character recognition (OCR). In accordance with the instruction provided by the print instruction unit 114, the printer outputs a paper document, which is generated by printing the document ID in a specified form and the content of the document on paper. After causing the printer to output the paper document, the document processing unit 110 transmits the document ID and the user ID of the user who has requested printing to the operation history registration unit 122. The user ID transmitted here is a user ID as a result of the user authentication performed by the user authentication unit 102 for the user of the client 20 serving as a source of the request. The process performed by the operation history registration unit 122 after receiving the document ID and the user ID will be described below.

The operation receiving unit 120 receives information about an operation performed on the document (paper document having a document ID and content of the document printed thereon) output from the printer through the process performed by the document processing unit 110. As described above, the document having a document ID printed thereon is sequentially forwarded to one or more users in accordance with the progress of a job, and each user performs an operation in his/her charge in the job on the forwarded document. Examples of the operation include reception of a document, check and approval of the content of a document, and writing information by hand onto a document. In the first exemplary embodiment, a user who performs an operation on a paper document causes a reader (not illustrated) connected to the client 20 to read the document ID printed on the paper document. A device compatible with the print format of the document ID may be used as the reader. For example, a bar code reader may be used if the document ID is printed in the form of a barcode, and a QR code reader may be used if the document ID is printed in the form of a QR code. An optical character reader may be used if the document ID is printed with a font suitable for OCR. The document ID may be read before or after execution of an operation. One reading operation of the document ID may be performed every time an operation is performed on the paper document.

The client 20 according to the first exemplary embodiment receives an input of an operation type performed by the user on the document from which the document ID has been read. For example, the client 20 causes a display device (not illustrated) to display a list of operation types that are preset as the types of operation that may be performed on the document, and obtains an operation type selected by the user using an input device (not illustrated). The client 20 transmits the document ID read by the reader and the information representing the operation type selected by the user to the management server 10. The operation receiving unit 120 of the management server 10 obtains the document ID received by the management server 10 from the client 20. Furthermore, the operation receiving unit 120 obtains the user ID of the user who has provided an instruction to read the document ID, that is, the user ID of the operator who has performed an operation on the paper document. Although the description is omitted above, user authentication is performed by the user authentication unit 102 before reading of the document ID or when the management server 10 receives the read document ID. Thus, the operation receiving unit 120 may obtain the user ID of the operator from the user authentication unit 102. The operation receiving unit 120 supplies the document ID, the operation type, and the user ID of the operator, which have been obtained in the above-described manner, to the operation history registration unit 122.

The operation history registration unit 122 registers, in the operation history DB 124, an operation history representing the history of one or more operations performed on a document. The operation history registration unit 122 receives the document ID, the operation type, and the user ID of the operator from the operation receiving unit 120, and registers an operation history including the received operation type and user ID in the operation history DB 124 in association with the received document ID. The operation history registration unit 122 according to the first exemplary embodiment causes the operation history to include information representing the date/time when the operation was performed, in addition to the operation type and the user ID of the operator. For example, the date/time when the operation receiving unit 120 received the document ID and the operation type from the client 20 may be included in the operation history as the date/time when the operation was performed. Alternatively, the client 20 may obtain the date/time when the document ID printed on the paper document was read by the reader, and transmit the date/time together with the document ID and the operation type to the management server 10, so that the data/time may be included in the operation history.

In a case where the document processing unit 110 causes the printer to print an electronic document, the operation history registration unit 122 according to the first exemplary embodiment registers the operation history about the “print” operation performed on the document in the operation history DB 124. When receiving the document ID of the printed document and the user ID of the user who has requested printing from the document processing unit 110, the operation history registration unit 122 registers an operation history including the user ID, the operation type “print”, and the date/time when the printing was performed in the operation history DB 124 in association with the document ID.

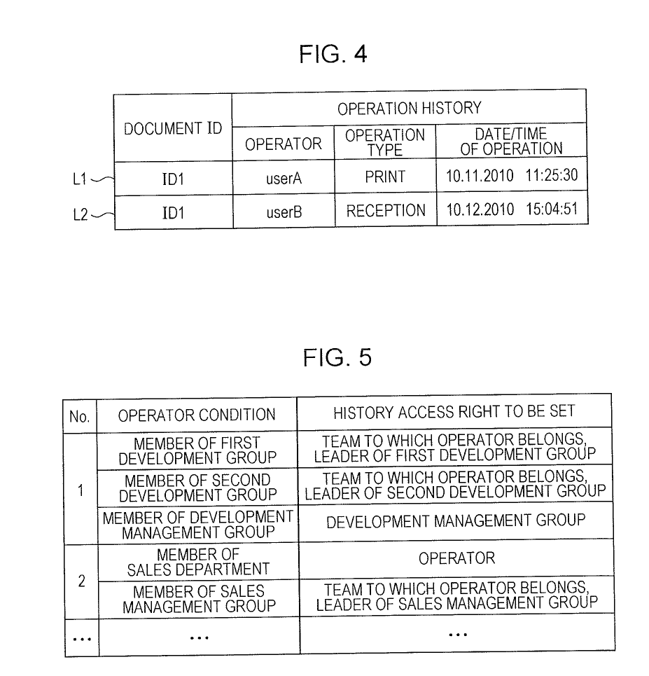

The operation history DB 124 is a database that stores history of operations performed on a document. FIG. 4 illustrates an example of the data content stored in the operation history DB 124. In the table illustrated in FIG. 4, an operation history is registered in association with a document ID. The operation history includes the items: operator, operation type, and date/time of operation. In a case where an operation history is registered in association with a document ID received by the operation receiving unit 120, the user ID of the operator, the operation type, and the date/time of the operation obtained by the operation receiving unit 120 are set to the respective items: operator, operation type, and date/time of operation. In a case where an operation history of printing of an electronic document performed by the document processing unit 110 is registered, the user ID of the user who has provided a print instruction, the operation type “print”, and the date/time when printing was performed are set to the respective items: operator, operation type, and date/time of operation. For example, the record shown in row L1 in the table illustrated in FIG. 4 represents that the operator “userA” performed a “print” operation on the document having the document ID “ID1” at the date/time “10.11.2010 11:25:30”. The record shown in row L2 represents that the operator “userB” performed a “reception” operation on the document having the document ID “ID1” at the date/time “10.12.2010 15:04:51”.

An example of the operation manner represented by the records shown in rows L1 and L2 in the table illustrated in FIG. 4 will be described in detail. First, the user “userA” creates an electronic document using the client 20, and requests the management server 10 to print the created electronic document. In response to the print request, the document ID assigning unit 112 of the document processing unit 110 provided in the management server 10 assigns the document ID “ID1” to the electronic document to be printed. In accordance with an instruction provided by the print instruction unit 114, a paper document having a machine-readable code representing the document ID “ID1” and the content of the electronic document printed thereon is output. The document processing unit 110 transmits the document ID “ID1” and the user ID “userA” to the operation history registration unit 122. Accordingly, the operation history registration unit 122 receives the document ID and the user ID, and registers the record shown in row L1 in the operation history DB 124. Subsequently, the paper document having the document ID “ID1” printed thereon is forwarded from the user “userA” to the user “userB”. The user “userB” causes the reader connected to the client 20 to read the document ID “ID1” of the forwarded paper document, and selects and inputs “reception” as an operation type using the input device of the client 20. The client 20 transmits the document ID “ID1” and the operation type “reception” to the management server 10. The operation receiving unit 120 of the management server 10 supplies the user ID “userB” to the operation history registration unit 122 together with the document ID “ID1” and the operation type “reception” received from the client 20. Then, the operation history registration unit 122 registers the record shown in row L2 in the operation history DB 124.

Referring back to FIG. 2, the history access right setting rule DB 130 is a database that stores rules (setting rules) for setting an access right for accessing the operation history of a document. A setting rule is predetermined by an administrator or user of the system and is registered in the history access right setting rule DB 130. A setting rule according to the first exemplary embodiment is defined by a set of a condition regarding an operator who performs an operation on a document and an access right to be set for the operation history of the document when the condition is satisfied. Hereinafter, an access right that is set for an operation history is referred to as a “history access right”. The history access right for the operation history of a certain document is set independently of an access right for the document. The content of the history access right may be different from the content of the access right for the document.

FIG. 5 illustrates an example of the content of setting rules that are registered in the history access right setting rule DB 130. In the table illustrated in FIG. 5, “No.” represents a setting rule number. The content of the setting rule of the corresponding number is represented by a set of “operator condition” and “history access right to be set”. The setting rule No. 1 illustrated in FIG. 5 (hereinafter also referred to as “setting rule 1”) includes three sets of “operator condition” and “history access right to be set”. The setting rule No. 2 (hereinafter also referred to as “setting rule 2”) includes two sets of “operator condition” and “history access right to be set”. “Operator condition” represents a condition regarding an operator included in the operation history registered in the operation history DB 124. The operator conditions illustrated in FIG. 5, that is, “member of first development group”, “member of second development group”, “member of development management group”, “member of sales department”, and “member of sales management group”, are satisfied when an operator included in the operation history belongs to the corresponding user group. “History access right to be set” represents the content of a history access right that is set for the operation history of a document related to the operation history including an operator who satisfies the corresponding operator condition. The content of the history access rights illustrated in FIG. 5 is defined by information indicating a user or user group permitted to view the operation history. For example, the history access right “team to which operator belongs, leader of first development group” corresponding to the operator condition “member of first development group” represents that, in a case where an operator included in the operation history belongs to “first development group”, a user who belongs to the team to which the operator belongs and a user who has a role of the leader of “first development group” are permitted to view the operation history of the document related to the operation history.

FIG. 5 illustrates two setting rules, but the history access right setting rule DB 130 may have one setting rule registered therein, or may have three or more setting rules registered therein. In a case where plural setting rules are registered in the history access right setting rule DB 130, the setting rule to be used for setting a history access right for the operation history of a document is determined by the history access right setting processing unit 132 in the following manner.

Referring back to FIG. 2, the history access right setting processing unit 132 performs a process of setting a history access right for an operation history registered in the operation history DB 124 with reference to the history access right setting rule DB 130. In the first exemplary embodiment, every time the operation history registration unit 122 registers an operation history in the operation history DB 124, the history access right setting processing unit 132 newly sets or updates a history access right for the operation history of the document having a document ID associated with the operation history. The history access right setting processing unit 132 determines the content of a history access right to be set for the operation history of the document in the history access right setting rule DB 130, and registers the history access right having the determined content in the history access right DB 134 in association with the document ID of the document related to the operation history.

In a case where plural setting rules are registered in the history access right setting rule DB 130, the history access right setting processing unit 132 may determine the setting rule to be used for setting a history access right by receiving a selection made by a user as an operator, for example. In this case, the history access right setting processing unit 132 transmits the content of the setting rules registered in the history access right setting rule DB 130 and information that induces a user to select a setting rule to the client 20 serving as a source of the user ID of the operator included in the operation history registered in the operation history DB 124 by the operation history registration unit 122, and causes the client 20 to display the content and the information. In accordance with the display, the user as an operator performs inputting to select a setting rule in the client 20. Accordingly, the identification information of the selected setting rule (for example, a setting rule number) is transmitted from the client 20 to the management server 10. The history access right setting processing unit 132 of the management server 10 may determine the content of a history access right in accordance with the selected setting rule.

Alternatively, setting rules to be used for determining the content of a history access right may be determined in advance for respective formats of documents, and a setting rule corresponding to the format of the document related to the operation history to be processed by the history access right setting processing unit 132 may be used. For example, in a case where a document to be forwarded in a job is created in accordance with any of plural predetermined formats, identification information of the formats corresponding to the plural setting rules is registered in advance in the history access right setting rule DB 130. Also, when the document ID assigning unit 112 of the document processing unit 110 assigns a document ID to an electronic document to be printed, the document processing unit 110 obtains the identification information of the format of the electronic document from the attribute information of the electronic document, and stores the document ID and the identification information of the format in a storage device (not illustrated) in association with each other. The history access right setting processing unit 132 may obtain the identification information of the format stored in association with the document ID of the document related to the operation history to be processed, may read out the setting rule corresponding to the identification information of this format from the history access right setting rule DB 130, and may set a history access right.

The history access right DB 134 is a database that stores a history access right set for an operation history of a document. The history access right DB 134 stores, for example, a history access right set for the operation history of a document by the history access right setting processing unit 132 in association with the document ID of the corresponding document. A specific example of the data content stored in the history access right DB 134 will be described below.

The history access controller 140 controls access to an operation history in accordance with a history access right registered in the history access right DB 134. For example, in a case where the management server 10 receives, from the client 20, a display request for requesting display of an operation history stored in the operation history DB 124, the history access controller 140 refers to the history access right DB 134, reads out, from the operation history DB 124, the operation history that the user of the client 20 as a source of the request is permitted to view, and causes the display device of the client 20 as the source of the request to display the operation history.

Referring to FIG. 6, a description will be given of an example of a procedure of a process in which the management server 10 according to the first exemplary embodiment sets a history access right for an operation history. The management server 10 starts the process illustrated in FIG. 6 when the document processing unit 110 performs a process of causing a printer to print out a paper document including a document ID in response to a print request from the client 20 or when the operation receiving unit 120 receives a document ID read from a paper document in the client 20 and an operation type selected by a user.

The operation history registration unit 122 of the management server 10 obtains information about an operation performed on a document (step S10). In a case where the process illustrated in FIG. 6 starts upon printout of a paper document caused by the print instruction unit 114 of the document processing unit 110, the operation history registration unit 122 obtains the document ID of the document to be printed, the user ID of the user who has requested printing, and the operation type “print” from the document processing unit 110 in step S10. In a case where the process illustrated in FIG. 6 starts upon reception of a document ID and an operation type by the operation receiving unit 120, the operation history registration unit 122 obtains the received document ID and operation type, and the user ID of the user of the client 20 serving as the source of the document ID and operation type from the operation receiving unit 120 in step S10. In a case where the operation receiving unit 120 further receives the date/time of the operation from the client 20, the operation history registration unit 122 also obtains the date/time of the operation.

The operation history registration unit 122 registers, in the operation history DB 124, an operation history including the information obtained in step S10 together with the document ID, in association with the document ID (step S12). The operation history illustrated in FIG. 4 is an example of the operation history registered in the operation history DB 124 in step S12. A user ID and an operation type obtained from the document processing unit 110 or the operation receiving unit 120 may be registered as “operator” and “operation type”, respectively, among the items of the operation history illustrated in FIG. 4. Information indicating the current date/time may be registered as the item “date/time of operation”. If the date/time of the operation is obtained from the operation receiving unit 120 in step S10, the obtained value may be registered as the item “date/time of operation”.

After having registered the operation history in the operation history DB 124, the operation history registration unit 122 notifies the history access right setting processing unit 132 of the content of the registered operation history and the document ID associated with the operation history. The history access right setting processing unit 132 that has received the notification evaluates a setting rule stored in the history access right setting rule DB 130 regarding the operation history (step S14). In step S14, the history access right setting processing unit 132 determines the setting rule to be used for setting a history access right in accordance with a selection made by the user or the format of the document identified by the document ID related to the operation history to be processed, as described above. Then, the history access right setting processing unit 132 determines whether or not the operator included in the operation history notified from the operation history registration unit 122 satisfies the operator condition defined in the determined setting rule with reference to the user/organization information DB 100. For example, in the case of using the setting rule 1 illustrated in FIG. 5, the history access right setting processing unit 132 determines whether or not the user ID of the operator included in the operation history is the user ID of a user who belongs to any of “first development group”, “second development group”, and “development management group”. In a case where information about “organization 1” illustrated in FIG. 3 is stored in the user/organization information DB 100 and where the record in row L1 in FIG. 4 is a target to be processed, the history access right setting processing unit 132 determines that the operator condition “member of first development group” in the setting rule 1 in FIG. 5 is satisfied because the operator “userA” belongs to the user group “development team A” included in “first development group”.

After step S14, the history access right setting processing unit 132 registers, in the history access right DB 134, a history access right for the operation history of the document related to the operation history registered in step S12 in accordance with the evaluation result of the setting rule (step S16). In step S16, if the operator included in the operation history to be processed satisfies the operator condition defined in the setting rule, the history access right setting processing unit 132 registers, in the history access right DB 134, the content of the history access right corresponding to the operator condition in the setting rule in association with the document ID notified from the operation history registration unit 122 together with the operation history. If any of the operator conditions defined in the setting rule is not satisfied, the history access right setting processing unit 132 may skip step S16, or may register a preset default history access right in the history access right DB 134 in association with the document ID of the operation history. The default history access right is set as an access right that allows a specific person, such as the administrator of the system, to view the operation history of the document.

After step S16, the process illustrated in FIG. 6 ends.

Hereinafter, a specific example of the history access right registered in the history access right DB 134 in step S16 in FIG. 6 will be described. In the description given below, it is assumed that information representing the configuration of “organization 1” illustrated in FIG. 3 is stored in the user/organization information DB 100 and that the setting rule 1 illustrated in FIG. 5 is used.

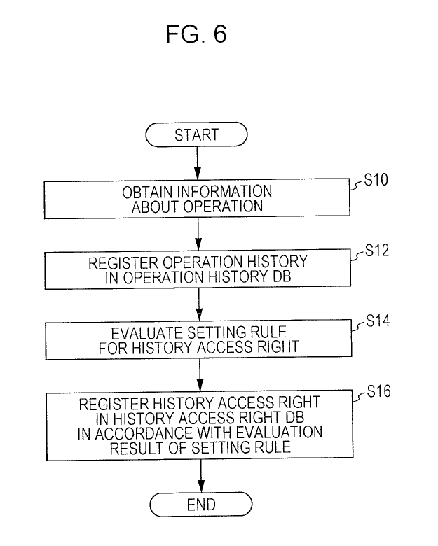

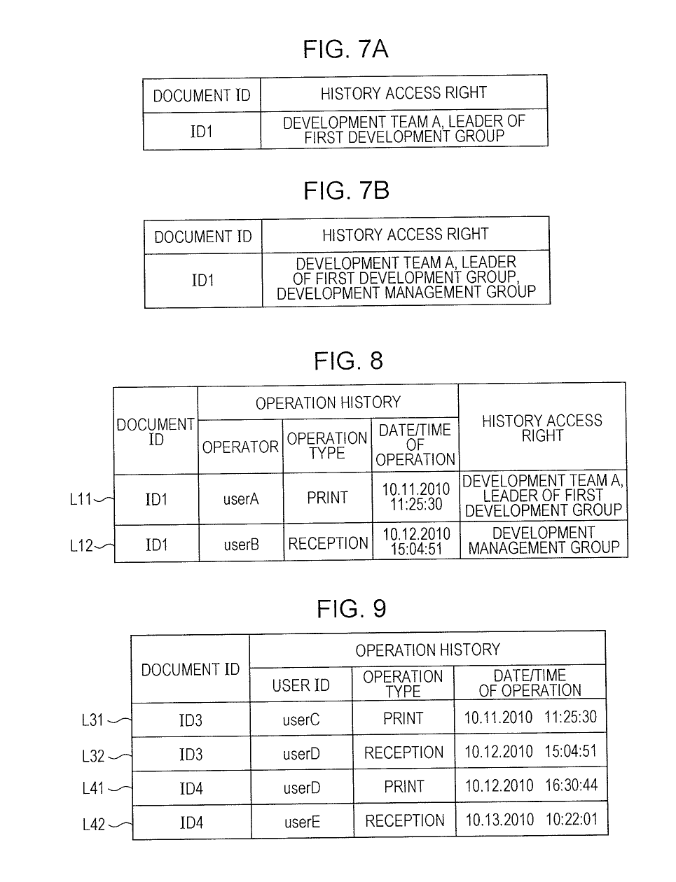

For example, it is assumed that the record in row L1 illustrated in FIG. 4 is registered in the operation history DB 124 in step S12 in FIG. 6 and that it is determined in step S14 that the operator condition “member of first development group” in the setting rule 1 is satisfied. In this case, the history access right setting processing unit 132 registers, in the history access right DB 134, the history access right “team to which operator belongs, leader of first development group” corresponding to the operator condition “member of first development group” in the setting rule 1 in association with the document ID “ID1”. An example of the content of the history access right registered in the history access right DB 134 in this case is illustrated in FIG. 7A. In FIG. 7A, the history access right “development team A, leader of first development group” is shown in association with the document ID “ID1”. In this history access right, “development team A” corresponds to “team to which operator belongs” in the setting rule 1, and is set when the history access right setting processing unit 132 reads out, from the user/organization information DB 100, the identification information “development team A” of the team to which the operator “userA” belongs. “Leader of first development group” is as described in the setting rule 1.

Next, the following case is assumed in which, after the history access right illustrated in FIG. 7A has been registered in the history access right DB 134, the user “userB” performs a “reception” operation on the document having the document ID “ID1”, whereby the operation receiving unit 120 of the management server 10 receives the user ID “userB” and the operation type “reception” and the process illustrated in FIG. 6 is started again. In this case, the record in row L2 in FIG. 4 is registered in the operation history DB 124 in step S12. In step S14, the history access right setting processing unit 132 evaluates the operator condition of the setting rule 1 regarding the operator “userB”, and determines that the operator condition “member of development management group” is satisfied (see FIG. 3). Accordingly, in step S16, the history access right setting processing unit 132 registers, in the history access right DB 134, the history access right “development management group” corresponding to the operator condition “member of development management group” in association with the document ID “ID1”. In this case, the history access right setting processing unit 132 registers, in the history access right DB 134, the history access right “development management group” having the content corresponding to the operator condition that the operator “userB” satisfies, in addition to the history access right that has been registered in association with the document ID “ID1” (see FIG. 7A). FIG. 7B illustrates an example of the history access right registered in the history access right DB 134 at this time in association with the document ID “ID1”. The history access right illustrated in FIG. 7B represents that a user who belongs to “development team A”, a user who has the role of “leader of first development group”, and a user who belongs to “development management group” are permitted to view the operation history of the document identified by the document ID “ID1”.

In the example described above with reference to FIGS. 7A and 7B, in a case where there is a history access right that has been registered in the history access right DB 134 in association with the document ID corresponding to a target of registration of a history access right in step S16 in FIG. 6, the history access right corresponding to the operator condition satisfied in the setting rule is registered in association with the document ID, in addition to the registered history access right. Alternatively, the registered history access right associated with the document ID may be deleted, and the history access right corresponding to the operator condition satisfied by an operator included in the operation history that is currently processed may be registered in the history access right DB 134 in association with the document ID.

Furthermore, a setting rule may define how to process a history access right that has been registered in association with the document ID of a document related to an operation history including an operator who satisfies an operator condition. For example, referring to FIG. 5, information indicating addition to a registered history access right or deletion from a registered history access right is registered in the history access right setting rule DB 130 for each of the user groups or roles shown in the item “history access right to be set”. In accordance with the information indicating addition or deletion in the setting rule, the history access right setting processing unit 132 may additionally register or delete the content corresponding to the user group or role of “history access right to be set” corresponding to the satisfied operator condition in or from the history access right DB 134. For example, “history access right to be set” in the setting rule is described as “+team to which operator belongs, −leader of sales management group”. In a case where the corresponding operator condition is satisfied, a history access right for permitting viewing by a user group corresponding to “team to which operator belongs” described together with the sign “+” is added to the history access right registered for the document ID of the corresponding document. If “leader of sales management group” described together with the sign “−” is included the registered access right for the document ID, “leader of sales management group” is deleted.

In the example of representing addition and deletion of a history access right using the signs “+” and “−”, if a history access right of a setting rule is described without adding any of the signs “+” and “−”, all the history access rights registered for the corresponding document ID may be deleted, thereby representing that the history access right described in the setting rule is newly registered.

In the above-described first exemplary embodiment, a history access right for accessing an operation history of a document is set for each document ID (see FIGS. 7A and 7B). In a modification of the first exemplary embodiment, a history access right may be set for each record of an operation history registered in the operation history DB 124. In this modification, the content of history access rights that are set for the operation history may be registered in association with the respective records stored in the operation history DB 124. Thus, in this modification, the management server 10 may not have the history access right DB 134. An example of the data content stored in the operation history DB 124 according to this modification is illustrated in FIG. 8.

In the example illustrated in FIG. 8, the document ID and the content of the operation history are the same as those in the operation history DB 124 illustrated in FIG. 4. In the table illustrated in FIG. 8, the item “history access right” shows the history access rights that are set for the respective records in the corresponding rows. In this modification, the procedure of a process performed by the management server 10 to set a history access right for accessing the operation history may be the same as the foregoing example described above with reference to FIG. 6. However, in step S16, the history access right setting processing unit 132 does not register a history access right in association with a document ID, but registers, in the operation history DB 124, a history access right having the content corresponding to a result of evaluating a setting rule in step S14 in association with the operation history registered in the operation history DB 124 in step S12. The history access rights shown in the individual rows L11 and L12 illustrated in FIG. 8 are examples of history access rights that are registered in association with the respective records in step S16 in the case of using the setting rule 1 illustrated in FIG. 5. The operator “userA” shown in the record in row L11 in FIG. 8 satisfies the operator condition of the setting rule 1 “member of first development group”. Thus, the history access right “development team A, leader of first development group” having the content corresponding to the history access right “team to which operator belongs, leader of first development group” in the setting rule 1 is registered in row L11. Also, the operator “userB” shown in the record in row L12 in FIG. 8 satisfies the operator condition of the setting rule 1 “member of development management group”, and thus the history access right “development management group” in the setting rule 1 is registered in row L12.

The history access controller 140 controls access to an operation history of a document in accordance with the access rights that are set in the above-described manner. For example, it is assumed that the management server 10 receives a request for viewing an operation history stored in the operation history DB 124 from the client 20 in a case where the operation history illustrated in FIG. 4 is registered in the operation history DB 124 and where the history access right illustrated in FIG. 7B is registered in the history access right DB 134. The history access controller 140 refers to the user/organization information DB 100 and the history access right DB 134, and determines whether or not the user who has made the request corresponds to “development team A, leader of first development group, development management group” included in the history access right associated with the document ID “ID1” in the history access right DB 134. If the user corresponds to “development team A, leader of first development group, development management group”, the history access controller 140 transmits the operation history corresponding to the document ID “ID1” (rows L1 and L2 in FIG. 4) registered in the operation history DB 124 to the client 20 serving as a source of the request. If the user does not corresponding thereto, the history access controller 140 transmits, to the client 20, information indicating that viewing is not permitted. Also, for example, in a case where history access rights are set for individual records of an operation history registered in the operation history DB 124, as illustrated in FIG. 8, the history access controller 140 determines, in response to a request for viewing the operation history, whether or not the user as a request source is permitted to view the operation history using a history access right in units of the records stored in the operation history DB 124, and transmits a record that is permitted to be viewed to the client 20 as the request source. In any case, only a record that is permitted to be viewed by a user who has requested viewing of an operation history using a history access right is transmitted to the client 20 as the request source. Thus, the user as the request source is incapable of viewing a record that is not permitted to be viewed. Also, one or more records that are permitted to be viewed in an operation history registered in the operation history DB 124 are provided to the user as the request source.

### Second Exemplary Embodiment

In a second exemplary embodiment, a setting rule for setting a history access right includes not only a condition regarding an operator but also a condition regarding an operation type. In the second exemplary embodiment, the management server 10 may have the same configuration as that in the first exemplary embodiment illustrated in FIG. 2.

In the management server 10 according to the second exemplary embodiment, a process of registering an operation history in the operation history DB 124 may be the same as that in the first exemplary embodiment. That is, at the time when an electronic document is printed, the management server 10 according to the second exemplary embodiment assigns a document ID to the document, outputs a paper document including the document ID, and registers a record of the “print” operation in the operation history DB 124. Also, in the management server 10 that has received the document ID read from the paper document and the operation type selected by the user from the client 20, the operation history registration unit 122 registers the operation history of the document identified by the document ID in the operation history DB 124.

It is assumed that the information about the organization illustrated in FIG. 3 described above in the first exemplary embodiment is stored in the user/organization information DB 100. Here, assume a case where a paper document that has been created by a user who belongs to “sales department” and that has been printed out is forwarded to a user in “first sales support team” or “second sales support team” of “sales management group” and is processed in a job conducted by “sales department” of “organization 1” illustrated in FIG. 3.

FIG. 9 is a diagram illustrating an example of the data content registered in the operation history DB 124 in a case where the user “userC”, “userD”, or “userE” performs an operation on the two documents identified by the document IDs “ID3” and “ID4”. Rows L31 and L32 in the table illustrated in FIG. 9 show that the user “userC” has performed “print” on a document to generate the document identified by the document ID “ID3”, and that the document has been forwarded to the user “userD” and a “reception” operation has been performed thereon. Rows L41 and L42 in the table illustrated in FIG. 9 show that the user “userD” has performed “print” on a document to generate the document identified by the document ID “ID4”, and that the document has been forwarded to the user “userE” and a “reception” operation has been performed thereon.

In the case of using a setting rule in which a history access right set for an operation history is determined simply on the basis of an operator condition, as in the first exemplary embodiment, it is possible that an operator included in the operation history satisfies plural operator conditions in the setting rule. For example, assume the case of setting a history access right for the records in rows L32 and L41 in FIG. 9 using the setting rule 2 illustrated in FIG. 5. The operator “userD” belongs to both “sales department” and “sales management group” (see FIG. 3), and thus satisfies two operator conditions “member of sales department” and “member of sales management group” in the setting rule 2. Thus, the history access right to be set is not uniquely determined.

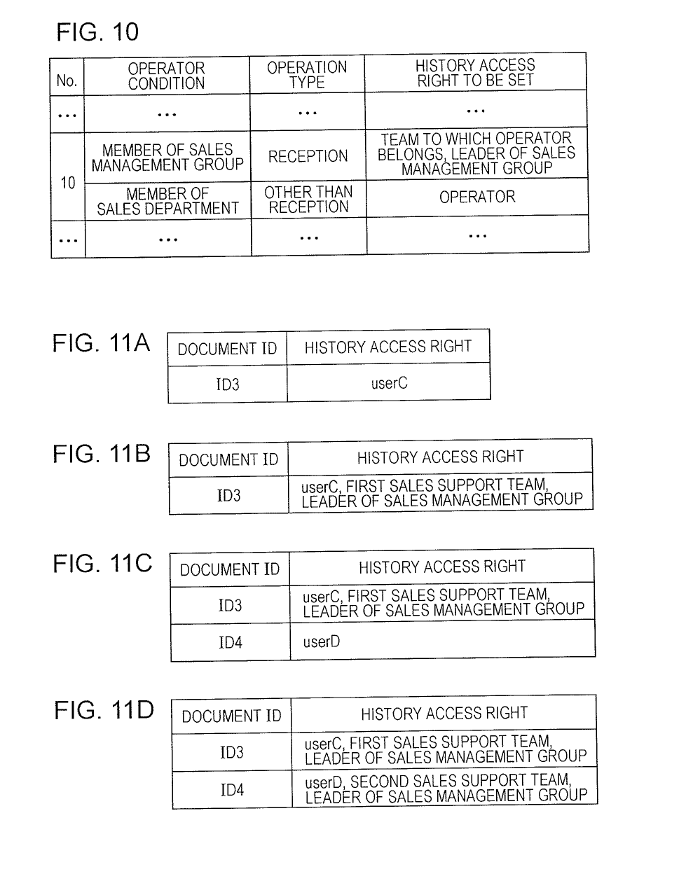

Therefore, in the second exemplary embodiment, a setting rule for determining a history access right on the basis of not only an operator condition but also an operation type condition is defined in setting rules for setting a history access right. FIG. 10 illustrates an example of a setting rule that is registered in the history access right setting rule DB 130 in the second exemplary embodiment. The table illustrated in FIG. 10 includes the item “operation type” in addition to the items “No.”, “operator condition”, and “history access right to be set” that are the same as in the table illustrated in FIG. 5. The item “operation type” shows a condition regarding an operation type included in an operation history to be processed by the history access right setting processing unit 132. In the setting rule illustrated in FIG. 10, a set of “operator condition” and “operation type” represents a condition that is to be satisfied by an operation history, and “history access right to be set” corresponding to the set represents the history access right that is to be set for an operation history that satisfies the condition. Thus, in a case where the setting rule illustrated in FIG. 10 is used and where an operator included in the operation history to be processed satisfies “operator condition” in the setting rule and an operation type included in the operation history to be processed corresponds to “operation type” in the setting rule, the history access right setting processing unit 132 sets, for the operation history of the document related to the operation history to be processed, the history access right having the content represented by “history access right to be set” corresponding to the “operator condition” and the “operation type”.

Hereinafter, a description will be given of an example of a process of setting a history access right in accordance with the setting rule No. 10 illustrated in FIG. 10 (hereinafter referred to as “setting rule 10”) in a case where the records in individual rows L31, L32, L41, and L42 illustrated in FIG. 9 are sequentially registered in the operation history DB 124. In this example, the procedure of the process performed by the management server 10 may be the same as that in the first exemplary embodiment described above with reference to FIG. 6.

After the record in row L31 illustrated in FIG. 9 has been registered in the operation history DB 124, the history access right setting processing unit 132 determines whether or not the operator “userC” and the operation type “print” in the record satisfy any of the two sets of an operator condition and an operation type included in the setting rule 10. The user “userC” belongs to “first sales group”, which is a user group included in “sales department” (see FIG. 3). Thus, the user “userC” does not satisfy the operator condition “member of sales management group” in the setting rule 10, but satisfies the operator condition “member of sales department”. The operation type “print” in the record in row L31 corresponds to the operation type “other than reception” corresponding to the operator condition “member of sales department” in the setting rule 10. Thus, the record in row L31 satisfies the condition represented by the set of the operator condition “member of sales department” and the operation type “other than reception” in the setting rule 10. Therefore, a history access right having the content corresponding to the history access right “operator” corresponding to this set is registered in the history access right DB 134 by the history access right setting processing unit 132 in association with the document ID “ID3” of the document related to the record. An example of the data content stored in the history access right DB 134 at this time is illustrated in FIG. 11A. The set of the document ID “ID3” and the history access right “userC” shown in the table illustrated in FIG. 11A represents that the operator “userC” who has performed the “print” operation on the document identified by the document ID “ID3” is capable of viewing the operation history of the document identified by the document ID “ID3”.

When the record of “reception” by the user “userD” of the document identified by the document ID “ID3” printed by the user “userC” (row L32 in FIG. 9) is registered in the operation history DB 124, the setting rule 10 is evaluated for the operator “userD” and the operation type “reception” in the record. The operator “userD” belongs to “first sales support team”, which is a user group included in the user group “sales management group” included in the department “sales department”. Thus, the two operator conditions “member of sales management group” and “member o sales department” included in the setting rule 10 are satisfied. However, the operation performed here by the operator “userD” is “reception”, which corresponds to “reception” in the two operation types “reception” and “other than reception” included in the setting rule 10. Thus, the history access right setting processing unit 132 additionally registers, in the history access right DB 134, the history access right “team to which operator belongs, leader of sales management group” corresponding to the set of the operator condition “member of sales management group” and the operation type “reception” in association with the document ID “ID3”. An example of the data content stored in the history access right DB 134 as a result of the registration is illustrated in FIG. 11B. In the history access right “userC, first sales support team, leader of sales management group” associated with the document ID “ID3” in the example illustrated in FIG. 11B, “userC” is registered in the history access right DB 134 at the time of registration of the record in row L31 (“print” performed by “userC”), and “first sales support team, leader of sales management group” is registered in the history access right DB 134 at the time of registration of the record in row L32 (“reception” performed by “userD”).

Furthermore, after the record in row L41 in FIG. 9 has been registered in the operation history DB 124, the history access right setting processing unit 132 evaluates the setting rule 10, and determines that the operator “userD” and the operation type “print” in the record satisfy the condition represented by the set of the operator condition “member of sales department” and the operation type “other than reception” in the setting rule 10. Thus, the history access right setting processing unit 132 registers, in the history access right DB 134, the history access right “operator” corresponding to the set of the operator condition “member of sales department” and the operation type “other than reception” in association with the document ID “ID4” of the document related to the record in row L41. FIG. 11C illustrates an example of the data content stored in the history access right DB 134 at this time. In the example illustrated in FIG. 11C, a history access right having the content registered in the above-described manner in the history access right DB 134 (see FIG. 11B) in accordance with the registration of the records in rows L31 and L32 is registered in association with the document ID “ID3”, and a history access right including the operator “userD” of the “print” operation performed on the document identified by the document ID “ID4” is registered in association with the document ID “ID4”.

Furthermore, after the record of the “reception” operation by the operator “userE” of the document identified by the document ID “ID4” (row L42 in FIG. 9) has been registered in the operation history DB 124, the history access right setting processing unit 132 evaluates the setting rule 10 for the operator “userE” and the operation type “reception”. The operator “userE” belongs to the user group “second sales support team” included in the user group “sales management group” included in the department “sales department” (see FIG. 3). Thus, the operator “userE” and the operation type “reception” in the record in row L42 satisfy the condition represented by the set of the operator condition “member of sales management group” and the operation type “reception” in the setting rule 10. Therefore, the history access right setting processing unit 132 registers, in the history access right DB 134, the history access right “team to which operator belongs, leader of sales management group” corresponding to the set of the operator condition “member of sales management group” and the operation type “reception” in association with the document ID “ID4”. An example of the data content stored in the history access right DB 134 as a result of the registration is illustrated in FIG. 11D. The history access right associated with the document ID “ID4” includes the operator “userD” of the “print” operation, “second sales support team”, which is a team to which the operator “userE” of the “reception” operation belongs, and “leader of sales management group”.

In the second exemplary embodiment, a history access right may be set for each record, not for each document ID, as in the modification of the first exemplary embodiment described above with reference to FIG. 8.

### Third Exemplary Embodiment

In a third exemplary embodiment, a deletion rule for deleting a history access right that has been set is determined in advance in addition to a setting rule for setting a history access right, and a history access right is deleted in accordance with the deletion rule.

In the above-described first and second exemplary embodiments, a printed document is sequentially forwarded to users, and a history access right for permitting viewing of the operation history of the document is set for a user who has performed an operation on the forwarded document and a user in a user group to which the user belongs. However, for example, in the case of forwarding a document in which the route of forwarding the document to users in a specific user group in specific order (forwarding route) is determined in advance in an organization, if the document is forwarded in a wrong forwarding route and an operation is performed on the document, a history access right for permitting viewing of the operation history of the document may be set for an operator who is not permitted to operate the document or a user in the user group to which the operator belongs in the first and second exemplary embodiments. In the third exemplary embodiment, a deletion rule is determined in advance, and a history access right is deleted in accordance with the deletion rule. The deletion rule includes a condition for specifying a history access right that is estimated to have been registered through forwarding of a document in a wrong forwarding route and an operation performed thereon, and a history access right that is to be deleted when the condition is satisfied.

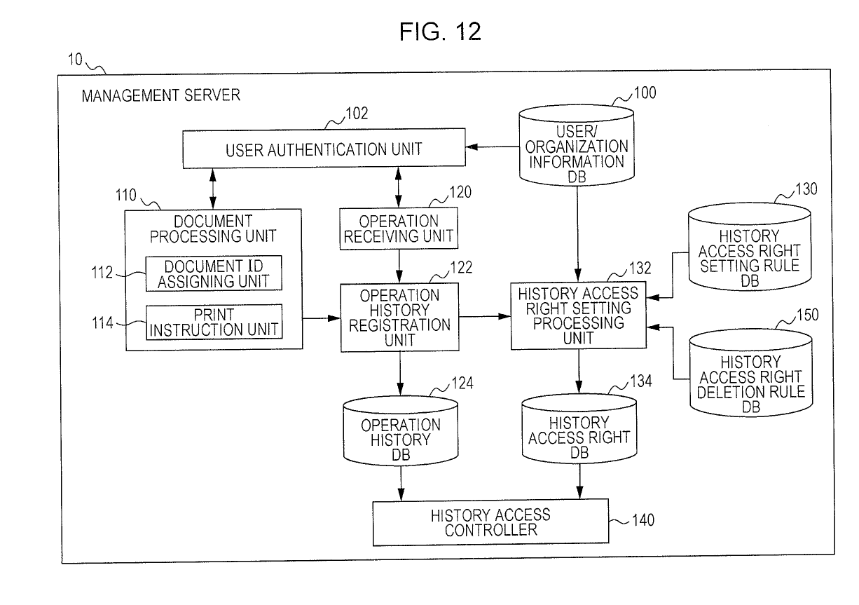

FIG. 12 illustrates an example of a schematic inner configuration of the management server 10 according to the third exemplary embodiment. The management server 10 illustrated in FIG. 12 includes a history access right deletion rule DB 150, in addition to the elements included in the management server 10 illustrated in FIG. 2 according to the first and second exemplary embodiments. In FIG. 12, the elements that are the same as those of the management server 10 illustrated in FIG. 2 are denoted by the same reference numerals, and the detailed description thereof is omitted.

A deletion rule registered in the history access right deletion rule DB 150 is a rule of deleting, in a case where an operation history processed by the history access right setting processing unit 132 satisfies a specific condition, at least part of history access rights that are set for the operation history of the document related to the operation history.

After the operation history registration unit 122 has registered an operation history in the operation history DB 124, the history access right setting processing unit 132 sets a history access right for the operation history using a setting rule stored in the history access right setting rule DB 130 as in the first and second exemplary embodiments, and evaluates a deletion rule stored in the history access right deletion rule DB 150. If there is a history access right to be deleted as a result of the evaluation, the history access right setting processing unit 132 deletes the history access right from the history access right DB 134.

The process of evaluating the deletion rule and deleting the history access right performed by the history access right setting processing unit 132 may be performed, for example, before step S14 (evaluation of a setting rule) or after step S16 (registration of a history access right) in the process illustrated in FIG. 6 according to the first exemplary embodiment.

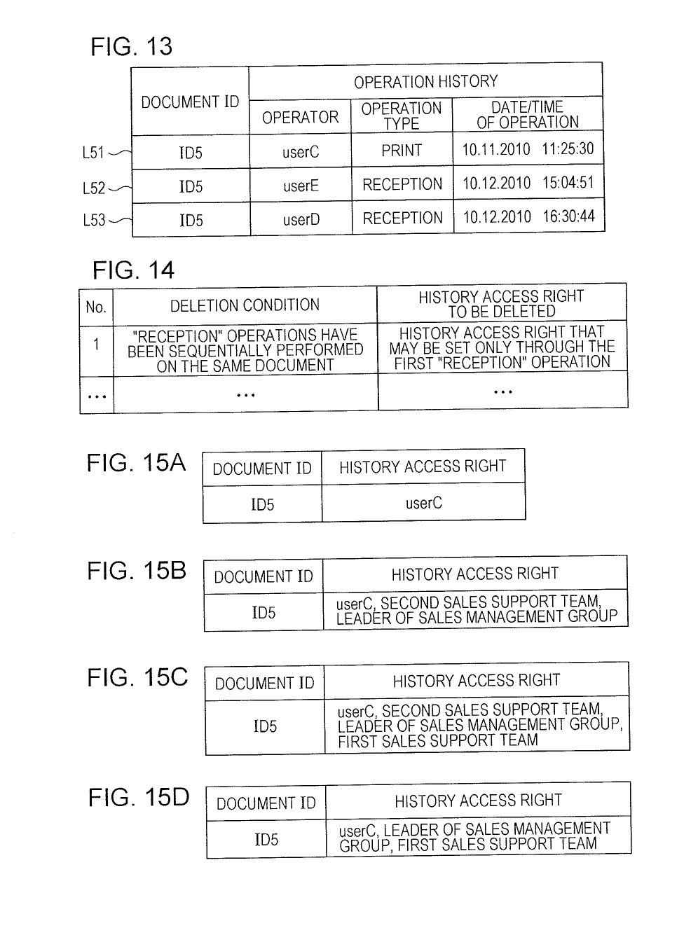

As a specific example for describing the third exemplary embodiment, a case is assumed where the setting rule 10 illustrated in FIG. 10 is used for setting a history access right and where a user who has performed a “print” operation on a document that is to be forwarded to a user in “first sales support team” in “organization 1” illustrated in FIG. 3 forwards the document to a user in “second sales support team” by mistake. FIG. 13 illustrates an example of an operation history registered in the operation history DB 124 in this specific example. Referring to FIG. 13, the user “userC” creates a document and performs a “print” operation on the document. Accordingly, the document ID “ID5” is assigned to the document, and the record in row L51 is registered in the operation history DB 124. It is assumed that the document identified by the document ID “ID5” is a document that is to be forwarded to a user in “first sales support team”. However, the user “userC” forwards the document to the user “userE” in “second sales support team” by mistake. A “reception” operation is performed on the document by the user “userE”, and the record in row L52 is registered in the operation history DB 124. After that, it is determined that the “reception” operation performed by the user “userE” is a mistake, and the document is forwarded to the user “userD” in “first sales support team”, who is an appropriate receiver of the document. Then, a “reception” operation is performed on the document by the user “userD”, and the record thereof (row L53) is registered in the operation history DB 124.

If the setting rule 10 illustrated in FIG. 10 is used for setting a history access right in a case where operations are performed on the document identified by the document ID “ID5” in the procedure described above with reference to FIG. 13, the history access right for the document identified by the document ID “ID5” includes “userC”, who is an operator of the “print” operation, “second sales support team”, which is a team to which a wrong operator of the “reception” operation belongs, “first sales support team”, which is a team to which an appropriate operator of the second “reception” operation belongs, and “leader of sales management group”, who is common to the two “reception” operations. A deletion rule for specifying and deleting the history access right “second sales support team” that is set through the wrong “reception” operation is defined and registered in the history access right deletion rule DB 150 in advance.

FIG. 14 illustrates an example of a deletion rule registered in the history access right deletion rule DB 150. In the table illustrated in FIG. 14, “No.” represents a deletion rule number. “Deletion condition” represents a condition for specifying a history access right to be deleted, and “history access right to be deleted” represents a history access right that is to be deleted from the history access right DB 134 when the corresponding deletion condition is satisfied. The deletion condition ““reception” operations have been sequentially performed on the same document” in the deletion rule No. 1 illustrated in FIG. 14 (hereinafter also referred to as “deletion rule 1”) is satisfied in a case where records of “reception” operations have been sequentially registered in the operation history DB 124 in association with the same document ID. Also, the history access right to be deleted in the deletion rule 1 “history access right that may be set only through the first “reception” operation” represents, in a case where the corresponding deletion condition is satisfied, deleting a history access right that may be registered in the history access right DB 134 in association with the document ID of the document only through the first “reception” operation among the “reception” operations sequentially performed on the same document.

Hereinafter, a description will be given of a case where the history access right setting processing unit 132 sets and deletes a history access right in accordance with the setting rule 10 illustrated in FIG. 10 and the deletion rule 1 illustrated in FIG. 14 when the records in rows L51 to L53 in FIG. 13 are registered in the operation history DB 124.

After the record of the “print” operation performed by the operator “userC” (row L51) has been registered in the operation history DB 124, the history access right setting processing unit 132 refers to the setting rule 10, and determines that the record satisfies the operator condition “member of sales department” and corresponds to the operation type “other than reception”. Then, in accordance with the setting rule 10, the history access right setting processing unit 132 registers, in the history access right DB 134, the user ID “userC” corresponding to the history access right “operator” corresponding to the operator condition and the operation type in association with the document ID “ID5” of the document related to the record to be processed. Furthermore, the history access right setting processing unit 132 evaluates the deletion rule 1. At this time, only the record of the “print” operation is registered in association with the document ID “ID5”. Thus, the history access right setting processing unit 132 determines that the above-described deletion condition ““reception” operations have been sequentially performed on the same document” is not satisfied, and does not delete the history access right registered in the history access right DB 134 in association with the document ID “ID5”. An example of the data content stored in the history access right DB 134 at this time is illustrated in FIG. 15A.

Subsequently, when the record of the “reception” operation performed by the operator “userE” (row L52) is registered in the operation history DB 124, the history access right setting processing unit 132 evaluates the setting rule 10. The record in row L52 satisfies the operator condition “member of sales management group” and the operation type “reception” in the setting rule 10. Thus, the history access right setting processing unit 132 additionally registers, in the history access right DB 134, the history access right “second sales support team, leader of sales management group” having the content corresponding to the history access right “team to which operator belongs, leader of sales management group” corresponding to the operator condition and the operation type in association with the document ID “ID5”. FIG. 15B illustrates an example of the data content stored in the history access right DB 134 at this time. Furthermore, the history access right setting processing unit 132 evaluates the deletion rule 1. At this time, only the records of the “print” operation and the “reception” operation (rows L51 and L52) are registered in the operation history DB 124 in association with the document ID “ID5”. Thus, the history access right setting processing unit 132 determines that the deletion condition ““reception” operations have been sequentially performed on the same document” in the deletion rule 1 is not satisfied. Thus, the history access right setting processing unit 132 does not delete a history access right at this time.

After the record of the “reception” operation performed by the operator “userD” (row L53) has been registered in the operation history DB 124, the history access right setting processing unit 132 evaluates the setting rule 10, and determines that the record satisfies the operator condition “member of sales management group” and the operation type “reception” in the setting rule 10. Then, the history access right setting processing unit 132 additionally registers, in the history access right DB 134, “first sales support team” which is unregistered in association with the document ID “ID5” in the history access right “first sales support team, leader of sales management group” having the content corresponding to the history access right “team to which operator belongs, leader of sales management group” corresponding to the operator condition and the operation type in the setting rule 10, in association with the document ID “ID5”. FIG. 15C illustrates an example of the data content stored in the history access right DB 134 at this time.

Furthermore, the history access right setting processing unit 132 evaluates the deletion rule 1 regarding the record in row L53 in FIG. 13. Referring to FIG. 13, the records of the “reception” operations have been registered in association with the document ID “ID5” at the time point where the record in row L53 is registered in the operation history DB 124. Thus, the history access right setting processing unit 132 determines that the deletion condition ““reception” operations have been sequentially performed on the same document” in the deletion rule 1 is satisfied, and specifies the history access right “history access right that may be set only through the first “reception” operation” to be deleted in accordance with the deletion rule 1. In this example, the record of the first “reception” operation is the record in row L52 in FIG. 13, and the history access right registered in the history access right DB 134 in accordance with registration of the record in the operation history DB 124 is “second sales support team, leader of sales management group”. In this history access right, “second sales support team” corresponds to “team to which operator belongs”, which is part of the history access right obtained as a result of evaluating the setting rule 10 regarding the record of the first “reception” operation (row L52), and does not correspond to any history access right obtained as a result of evaluating the setting rule 10 regarding the other records (rows L51 and L53) of the document ID “ID5”. On the other hand, “leader of sales management group” may be registered in the history access right DB 134 in association with the document ID “ID5” as a result of evaluating the setting rule 10 regarding the record of the second “reception” operation (row L53), as described above. In this way, the history access right setting processing unit 132 specifies, as a history access right to be deleted, the history access right “second sales support team” corresponding to the result of evaluating the setting rule 10 regarding the record in row L53. The history access right setting processing unit 132 deletes the history access right “second sales support team” specified to be deleted among the history access rights registered in the history access right DB 134 in association with the document ID “ID5”. An example of the data content stored in the history access right DB 134 after the deletion is illustrated in FIG. 15D.

In the example described above with reference to FIGS. 15A to 15D, a registered history access right is deleted in accordance with the deletion rule 1 illustrated in FIG. 14. Accordingly, the history access right “second sales support team”, which is set through the “reception” operation performed on the document (ID5) that is wrongly forwarded to the user “userE” in “second sales support team” in a route different from a predetermined forwarding route, is deleted from the history access right DB 134.

The content of the deletion rule used in the third exemplary embodiment is not limited to the content of the deletion rule 1 illustrated in FIG. 14. For example, in the deletion rule 1, a deletion condition ““reception” operation has been performed on the same document twice or more” may be used instead of the deletion condition ““reception” operations have been sequentially performed on the same document”. The deletion condition in this example is satisfied if two or more records of “reception” operations have been registered in the operation history DB 124 in association with the document ID of the document related to the operation history to be processed by the history access right setting processing unit 132, even if a record of an operation type other than “reception” is registered between the two or more records (that is, even if the “reception” operations are not sequential). Also, “operations of a specific operation type other than “reception” have been performed on the same document sequentially or plural times” may be used as a deletion condition, and a history access right to be deleted when this deletion condition is satisfied may be regarded as a history access right that may be set only by evaluating a setting rule regarding records of the specific operation type other than the latest record.

### Fourth Exemplary Embodiment

In the above-described first to third exemplary embodiments, a history access right for permitting viewing of the operation history of a forwarded document is set for a user who has performed an operation on the document and a user in a user group to which the user belongs. Thus, in the above-described first to third exemplary embodiments, a user in a certain user group is incapable of viewing the operation history of the document before the document is forwarded to and is operated by the user or another user who belongs to the user group.

In an organization, there may exist a user group that accepts documents submitted by various departments or sections, such as a department that accepts approval documents. It is appropriate that a user who belongs to such a user group be capable of viewing the operation history of a document before the document is forwarded to a user who belongs to the user group in order to estimate the amount of jobs of receiving documents later and to take necessary measures. However, in the above-described first to third exemplary embodiments, a user in a user group is incapable of viewing the operation history of a document before the document is forwarded to the user in the user group.

In the fourth exemplary embodiment, at the time when a document to be operated by a user in a certain user group is created, a history access right for permitting the user in the user group to view the operation history of the document is set. In order to set such a history access right, in the fourth exemplary embodiment, a history access right is set in accordance with forwarding of a document, and the history access right set for the operation history of the document that has actually been forwarded is recorded, as in the above-described first to third exemplary embodiments. Then, after a document of the same type as the actually forwarded document is newly created, a history access right similar to the history access right set for the actually forwarded document is set for the operation history of the newly created document. Here, the “document of the same type” as the actually forwarded document may be a document created in the same format as the actually forwarded document. Alternatively, a document created in the same format as the actually forwarded document by the same user (or a user who belongs to the same user group) may be handled as the “document of the same type”.

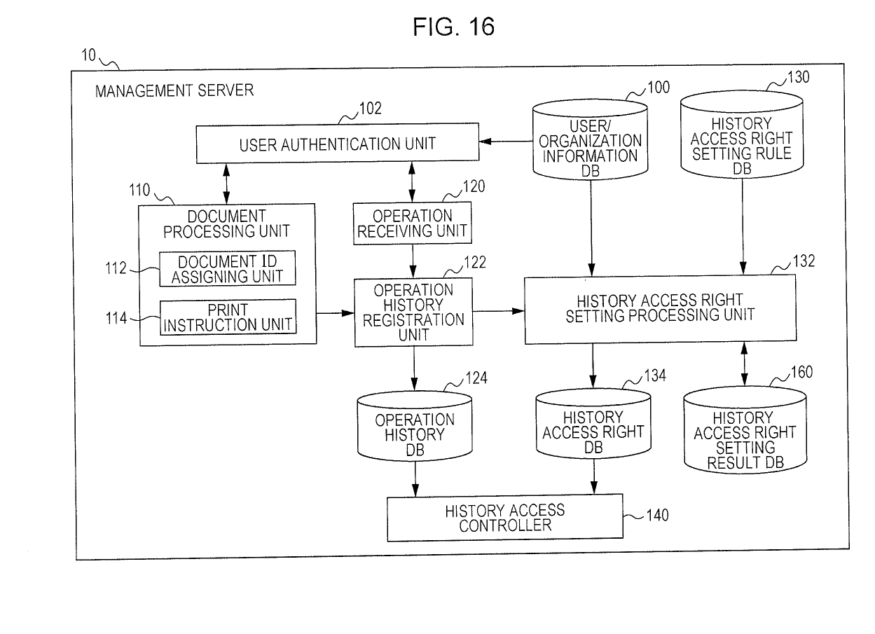

FIG. 16 illustrates an example of a schematic inner configuration of the management server 10 according to the fourth exemplary embodiment. The management server 10 illustrated in FIG. 16 includes a history access right setting result DB 160, in addition to the elements included in the management server 10 illustrated in FIG. 2 according to the first and second exemplary embodiments. In FIG. 16, the same elements as those in the management server 10 illustrated in FIG. 2 are denoted by the same reference numerals, and the detailed description thereof if omitted.

The history access right setting result DB 160 is a database that stores a history access right set for the operation history of an actually forwarded document. That is, the history access right setting result DB 160 stores the result of settings of history access rights for the operation histories of actually forwarded documents. For example, the history access right setting result DB 160 stores history access rights that are set for the operation histories of actually forwarded documents of respective types. In this exemplary embodiment, information indicating the type of document includes information about the format of the document and the user who has created the document. A specific example of the data content stored in the history access right setting result DB 160 will be described below.

In a case where an operation history as a target to be processed is the operation history of a document of a type unregistered in the history access right setting result DB 160, the history access right setting processing unit 130 according to the fourth exemplary embodiment sets a history access right in the same manner as in the first or second exemplary embodiment. Also, in the case of having performed a process of setting a history access right for an operation history that includes an operation type preset as an operation type of the operation that is performed last on a document, the history access right setting processing unit 132 registers, in the history access right setting result DB 160, the history access right registered in the history access right DB 134 in association with the document ID of the document related to the operation history, in association with the type of document. As the type of operation that is performed last on the document, the type of operation that is performed last in a job using the document may be set. Hereinafter, a description will be given of a case where “reception” is set as the type of operation that is performed last. Furthermore, in a case where the operation history as a target to be processed is the operation history of a document of a type registered in the history access right setting result DB 160, the history access right setting processing unit 132 registers, in the history access right DB 134, the history access right associated with the type in the history access right setting result DB 160, in association with the document ID of the document related to the operation history as the target to be processed.

Hereinafter, a specific example of the data content stored in the history access right setting result DB 160 will be described. In this example, as in the second exemplary embodiment described above with reference to FIGS. 9, 10, and 11A to 11D, it is assumed that the documents identified by the document IDs “ID3” and “ID4” are forwarded, the operation history illustrated in FIG. 9 is registered in the operation history DB 124 of the management server 10, and the history access rights having the content illustrated in FIG. 11D are registered in the history access right DB 134 in accordance with the setting rule 10 illustrated in FIG. 10. Also, it is assumed that the format of the document identified by the document ID “ID3” is “approval document 1”, and the format of the document identified by the document ID “ID4” is “approval document 2”. The information indicating the format of each document may be stored in a storage device (not illustrated) by associating the document ID of the document with the identification information of the format at the time when the document ID is assigned to the document. The history access right setting processing unit 132 evaluates the setting rule 10 and sets history access rights by regarding the record of a “reception” operation as a processing target regarding the documents identified by the document IDs “ID3” and “ID4”. Then, the history access right setting processing unit 132 registers, in the history access right setting result DB 160, the history access rights registered in the history access right DB 134 for the document IDs “ID3” and “ID4” (see FIG. 11D), in association with the formats of the respective documents “approval document 1” and “approval document 2”.

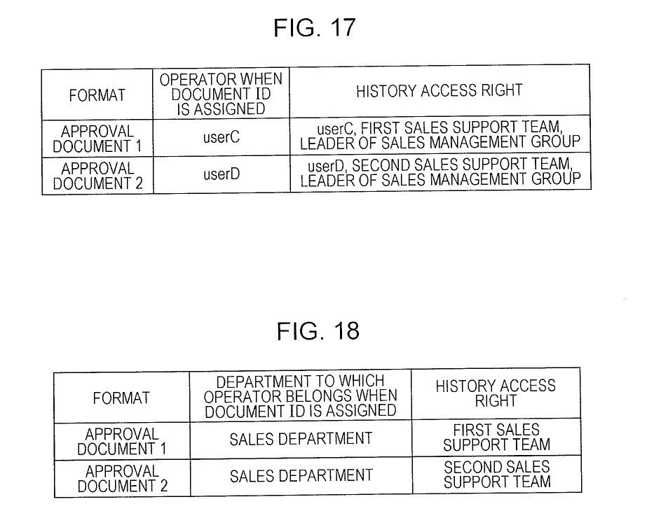

FIG. 17 illustrates an example of the data content stored in the history access right setting result DB 160. The table illustrated in FIG. 17 includes the items of format, operator when document ID is assigned, and history access right. The identification information of the format of an actually forwarded document is registered as the item of the format. The user ID of an operator who has performed an operation with which a document ID is assigned to the document of the corresponding format is registered as the item of the operator when document ID is assigned. In this exemplary embodiment, a document ID is assigned to a document when a “print” operation is performed on the document, and thus the operator who performs a “print” operation on the document is regarded as “operator when document ID is assigned”. In the example illustrated in FIG. 17, a set of a format and an operator when a document ID is assigned represents the type of document. The content of a history access right that is set for the operation history of a document which has a corresponding “format” and to which a document ID is assigned through an operation performed by the corresponding “operator when document ID is assigned” is registered as the item of the history access right. In the table illustrated in FIG. 17, the format “approval document 1” of the document identified by the document ID “ID3”, and the operator “userC” when the document ID of the document is assigned (operator of a “print” operation, see the record in row L31 in FIG. 9) are registered. Furthermore, the history access right “userC, first sales support team, leader of sales management group” set for the operation history of the document identified by the document ID “ID3” (see the row of the document ID “ID3” in FIG. 11D) is registered in association with the format “approval document 1” and the operator “userC” when the document ID is assigned. Also, in the table illustrated in FIG. 17, the history access right “userD, second sales support team, leader of sales management group” (see the row of the document ID “ID4” in FIG. 11D) is registered in association with a set of the format “approval document 2” of the document identified by the document ID “ID4” and the operator “userD” when the document ID of the document is assigned (operator of a “print” operation, see the record in row L41 in FIG. 9).

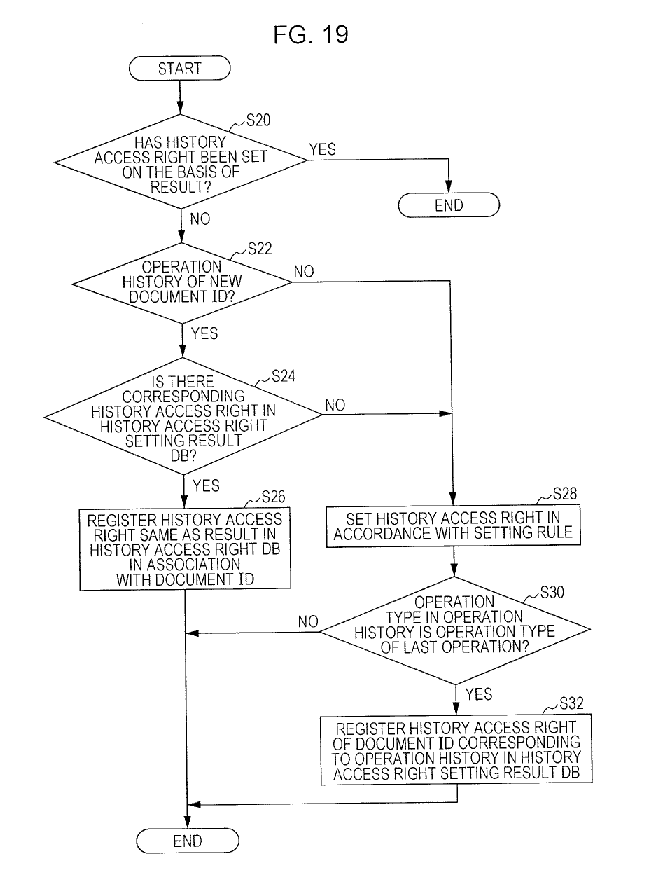

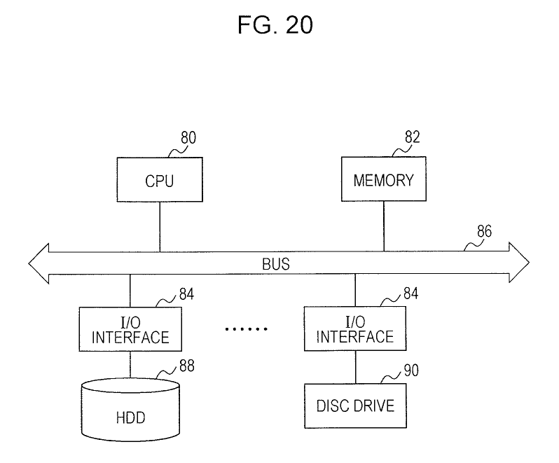

FIG. 18 illustrates another example of the data content stored in the history access right setting result DB 160. FIG. 18 illustrates another example of the data content stored in the history access right setting result DB 160 in a case where the operation history illustrated in FIG. 9 has been registered in the operation history DB 124 and the history access rights illustrated in FIG. 11D have been registered in the history access right DB 134 in the management server 10. The table illustrated in FIG. 18 includes the item “department to which operator belongs when document ID is assigned”, in stead of the item “operator when document ID is assigned” in FIG. 17. In the example illustrated in FIG. 18, the user ID of an operator at the time when a document ID is assigned to the document of a corresponding format is not registered in the history access right setting result DB 160, but the identification information of the department to which the operator belongs is registered therein. Thus, in the table illustrated in FIG. 18, “sales department”, which is the identification information of the department to which “userC” belongs, is registered as the “department to which operator belongs when document ID is assigned” in association with the format “approval document 1”, instead of the operator “userC” when a document ID is assigned in the table illustrated in FIG. 17. Also, in the table illustrated in FIG. 18, “sales department”, which is the department to which “userD” belongs, is registered in association with the format “approval document 2”, instead of the operator “userD” when a document ID is assigned in the table illustrated in FIG. 17. The identification information of the department to which an operator belongs may be obtained from the user/organization information DB 100 (see FIG. 3). In the item of the history access right in the table illustrated in FIG. 18, a history access right for a single user (“userC”, “userD”, “leader of sales management group”) is omitted among the history access rights registered in the history access right DB 134 in association with the document ID of an actually forwarded document, and a history access right for a user group (“first sales support team”, “second sales support team”) is registered.

When a document of the type registered in the history access right setting result DB 160 is newly created and when a document ID is assigned through an operation performed by an operator when the document ID associated with the type is assigned, the history access right setting processing unit 132 sets the history access right registered in the history access right setting result DB 160 for the operation history of the newly created document in association with the type. Thus, in a case where the data content illustrated in FIG. 17 is registered in the history access right setting result DB 160, when a document of the format “approval document 1” is newly printed by the user “userC” and a document ID is assigned thereto, the history access right “userC, first sales support team, leader of sales management group” is registered in the history access right DB 134 in association with the document ID. Furthermore, when a document of the format “approval document 2” is newly printed by the user “userD” and a document ID is assigned thereto, the history access right “userD, second sales support team, leader of sales management group” is registered in the history access right DB 134 in association with the document ID. In a case where the data content illustrated in FIG. 18 is registered in the history access right setting result DB 160, when a document of the format “approval document 1” is newly printed by a user who belongs to “sales department” and a document ID is assigned thereto, the history access right “first sales support team” is registered in the history access right DB 134 in association with the document ID. When a document of the format “approval document 2” is newly printed by a user who belongs to “sales department” and a document ID is assigned thereto, the history access right “second sales support team” is registered in the history access right DB 134 in association with the document ID. As a result of setting history access rights in the above-described manner with reference to the history access right setting result DB 160, a user who belongs to a user group to which a document of the corresponding type is forwarded is capable of viewing the operation history of the document before the document is forwarded to the user group.

If the history access right setting processing unit 132 registers, in the history access right DB 134, the history access right registered in the history access right setting result DB 160 in association with the document ID of a newly created document, the history access right setting processing unit 132 may further register the information indicating that the history access right has been registered on the basis of the result of setting of the history access right in association with the document ID. In accordance with the presence/absence of such information, if a history access right has been registered for the document ID of the document related to the operation history to be processed on the basis of the result of setting of a history access right, the history access right setting processing unit 132 may omit the process of evaluating a setting rule about the operation history and setting a history access right.

The data content stored in the history access right setting result DB 160 is not limited to the examples described above with reference to FIGS. 17 and 18. For example, in the examples illustrated in FIGS. 17 and 18, the items “operator when document ID is assigned” and “department to which operator belongs when document ID is assigned” may be omitted. In this case, a set of the format of an actually forwarded document and a history access right is registered in the history access right setting result DB 160. When a document of a registered format is newly created and a document ID is assigned thereto, the history access right corresponding to the format is set for the operation history of the newly created document.

Hereinafter, an example of a procedure of a process performed by the history access right setting processing unit 132 of the management server 10 according to the fourth exemplary embodiment will be described with reference to FIG. 19. The process illustrated in FIG. 19 is started by the history access right setting processing unit 132 after the operation history registration unit 122 has registered an operation history in the operation history DB 124 as in the first or second exemplary embodiment described above with reference to steps S10 and S12 in FIG. 6, and has notified the history access right setting processing unit 132 of the fact. The history access right setting processing unit 132 performs the process illustrated in FIG. 19 on the operation history registered in the operation history DB 124 in accordance with the notification from the operation history registration unit 122.

The history access right setting processing unit 132 determines whether or not a history access right has been set for the operation history of the document related to the operation history to be processed on the basis of the result of setting of the history access right for the operation history of the actually forwarded document (step S20). The determination in step S20 may be performed by, for example, determining whether or not information indicating that the history access right has been registered in the history access right DB 134 in association with the document ID of the document related to the operation history to be processed on the basis of the result of setting of the history access right has been registered.

If a history access right has been set for the operation history of the document related to the operation history to be processed on the basis of the result of setting of the history access right (YES in step S20), the history access right setting processing unit 132 ends the process illustrated in FIG. 19 without performing step S22 and the subsequent steps.

If a history access right has not been set for the operation history of the document related to the operation history to be processed on the basis of the result of setting of the history access right (NO in step S20), the history access right setting processing unit 132 determines whether or not the operation history to be processed is the operation history of a document identified by a new document ID (step S22). The determination in step S22 may be performed by, for example, determining whether or not an operation type included in the operation history to be processed is an operation type that is preset as the type of an operation through which a document ID is assigned. For example, in this example in which a document ID is assigned when a “print” operation is performed on a document, a positive determination is made in step S22 if the operation type included in the operation history to be processed is “print”, and a negative determination is made in step S22 if the operation type is an operation type other than “print”. Alternatively, with reference to the operation history DB 124, a positive determination may be made in step S22 if the operation history to be processed is the only operation history that is registered in association with the document ID related to the operation history, and a negative determination may be made in step S22 if another operation history is registered in association with the document ID.

If the operation history to be processed is the operation history of a document identified by a new document ID (YES in step S22), the history access right setting processing unit 132 determines whether or not the history access right corresponding to the type of document identified by the document ID of the document related to the operation history to be processed has been registered in the history access right setting result DB 160 (step S24). The determination in step S24 is performed with reference to the history access right setting result DB 160. For example, if the history access right setting result DB 160 includes the items of the table illustrated in FIG. 17 or 18, the history access right setting processing unit 132 determines whether or not the history access right corresponding to a set of the format of the document identified by the document ID to be determined and the operator (or the department to which the operator belongs) included in the operation history to be processed has been registered in the history access right setting result DB 160. If the format of the document and a history access right are registered in the history access right setting result DB 160, the history access right setting processing unit 132 may determine whether or not the history access right corresponding to the format of the document identified by the document ID to be determined has been registered in the history access right setting result DB 160.

If the history access right corresponding to the type of document identified by the document ID of the document related to the operation history to be processed has been registered in the history access right setting result DB 160 (YES in step S24), the history access right setting processing unit 132 registers, in the history access right DB 134, a history access right having the same content as the corresponding history access right registered in the history access right setting result DB 160 in association with the document ID (step S26). At this time, the history access right setting processing unit 132 further registers, in the history access right DB 134, information indicating that the history access right has been set on the basis of the result of setting of the history access right in association with the document ID.

If the operation history to be processed is not the operation history of the document identified by a new document ID (NO in step S22), or if the corresponding history access right is not registered in the history access right setting result DB 160 (NO in step S24), the history access right setting processing unit 132 sets a history access right in accordance with a setting rule stored in the history access right setting rule DB 132 (step S28). The process of setting a history access right performed in step S28 may be the same as the process performed by the history access right setting processing unit 132 in the first or second exemplary embodiment described above with reference to steps S14 and S16 in the process illustrated in FIG. 6.

After step S28, the history access right setting processing unit 132 determines whether or not the operation type included in the operation history to be processed is the operation type that is preset as the type of operation performed last on the document (step S30). In this example in which “reception” is set as the type of last operation, a positive determination is performed in step S30 if the operation type included in the operation history to be processed is “reception”, and a negative determination is performed if the operation type is an operation other than “reception”.

If the operation type included in the operation history to be processed is the type of last operation (YES in step S30), the history access right setting processing unit 132 registers, in the history access right setting result DB 160, the history access right registered in the history access right DB 134 in association with the document ID of the document related to the operation history, in association with the information indicating the type of document (step S32). For example, if the history access right setting result DB 160 includes the items of the table illustrated in FIG. 17 or 18, the type of document is represented by a set of the format of the document and an operator when a document ID is assigned or a department to which the operator belongs. Thus, in step S32, the history access right setting processing unit 132 registers, in the history access right setting result DB 160, a set of the format of the document related to the operation history to be processed and the operator or the department to which the operator belongs at the time when a document ID is assigned to the document related to the operation history to be processed, and furthermore registers, in the history access right setting result DB 160, the corresponding history access right registered in the history access right DB 134 in association with the set. In a case where the format of the document and the history access right are registered in the history access right setting result DB 160, the history access right setting processing unit 132 registers, in the history access right setting result DB 160, the corresponding history access right registered in the history access right DB 134, in association with the format of the document related to the operation history to be processed in step S32.

After step S26, after a negative determination is performed in step S30, or after step S32, the process illustrated in FIG. 19 ends.

If an operation history for which a history access right has been set is regarded as a target to be processed on the basis of the result of setting a history access right in the determination performed in step S20 in the process illustrated in FIG. 19, the process of setting a history access right is omitted. Also, by performing determinations in steps S22 and S24, if a history access right has been set for the operation history of an actually forwarded document and if a document of the same format as the actually forwarded document is newly created, the history access right that has been set for the operation history of the actually forwarded document is set for the operation history of the newly created document. If a document of another format is created, a history access right is set in accordance with a setting rule.

According to a modification of the above-described fourth exemplary embodiment, the determination performed in step S20 in the process illustrated in FIG. 19 may be omitted. In this modification, even after a history access right has been set for the operation history of a certain document on the basis of the result of setting a history access right, a setting rule is evaluated regarding the registered operation history, and the history access right registered in the history access right DB 134 in association with the document ID of the document is updated through the process in step S28 every time the operation history of the document is registered in the operation history DB 124.

In the fourth exemplary embodiment, the above-described process of using the history access right setting result DB 160 is performed in addition to the process according to the first or second exemplary embodiment. However, in the fourth exemplary embodiment, the process of using the history access right setting result DB 160 may be performed in addition to the process according to the third exemplary embodiment. For example, in step S28 in the process illustrated in FIG. 19, the process of deleting part of history access rights by evaluating a deletion rule may be performed as in the third exemplary embodiment, in addition to the process of setting a history access right by evaluating a setting rule regarding the operation history to be processed.

### Other Exemplary Embodiments

Exemplary embodiments of the present invention may include various modifications, in addition to the above-described first to fourth exemplary embodiments and the modifications thereof. For example, in the above-described exemplary embodiments and modifications, a document ID is assigned to an electronic document when the electronic document is printed to generate a paper document, the paper document having the document ID and the content of the electronic document printed thereon is forwarded to a user, and an operation history is recorded and a history access right is set for the operation history. The process according to the above-described exemplary embodiments and modifications may be applied to the case of forwarding an electronic document. For example, the file format of an electronic document created using a certain document processing application may be converted to a predetermined format as a file format suitable for forwarding, and the electronic document having the converted file format may be forwarded to a user. A document ID may be assigned to the electronic document at the time of such a “conversion” operation of converting the file format of the electronic document. The document ID assigned to the electronic document may be included in the attribute information of the electronic document, for example. An example of the file format suitable for forwarding is a file format in which editing using a document processing application is prevented, such as a portable document format (PDF). Also, forwarding of the electronic document may be performed through transmission of an electronic mail to which the electronic document is attached. The process according to the above-described exemplary embodiments and modifications may be performed in a manner similar to that described above, using the document ID included in the attribute information of the electronic document. Furthermore, a document ID may be assigned to the electronic document at the time of a “new registration” operation of registering a newly created electronic document in a document database.

In the above-described exemplary embodiments and modifications, a history access right is described as information indicating a user who is permitted to view an operation history (user ID, identification information of a user group, the role of a user in an organization, etc.). Alternatively, the history access right may be described as information indicating a user who is permitted to use an operation history in the form of “deletion”, “print”, etc., in addition to “view”. Alternatively, the history access right may be described as information indicating a user who is not permitted to use an operation history in the various usage forms, not a user who is permitted to use the operation history. The history access right may be described in any form as long as it is described so that a set of an entity that uses the operation history and the usage form that is permitted or not permitted for the entity is specified.

The above-described management server 10 is typically realized when a program that describes the individual functions or processes of the management server 10 is executed by a general-purpose computer. As illustrated in FIG. 20, the computer has a hardware circuit configuration in which a central processing unit (CPU) 80, a memory (first memory) 82, and input/output (I/O) interfaces 84 are connected to one another via a bus 86. Also, a hard disk drive (HDD) 88 and a disc drive 90 for reading data recorded on a portable nonvolatile recording medium of various standards, such as a compact disc (CD), a digital versatile disc (DVD), and a flash memory, are connected to the bus 86 via the I/O interfaces 84. The HDD 88 or the disc drive 90 functions as an external storage device with respect to the memory 82. A program that describes the processes of an exemplary embodiment is stored in a fixed storage device such as the HDD 88 via a recording medium such as a CD or DVD or via a network, and is installed in the computer. When the program stored in the fixed storage device is read out to the memory 82 and is executed by the CPU 80, the processes of the exemplary embodiment is realized. This is the same in the client 20.

In the exemplary embodiments described above, the management server 10 is realized by a single computer. Alternatively, the various functions of the management server 10 may be distributed to plural computers.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a registration unit that registers in an operation history memory, when obtaining operator information indicating an operator who has performed an operation on a document, document identification information of the document and an operation history including the obtained operator information in association with each other; and
a setting unit that refers to a setting rule memory that stores a setting rule which is a predetermined rule for setting a usage limitation for the operation history and which associates a setting condition with usage limitation information, the setting condition including a condition regarding the operator information, the usage limitation information indicating a set of an entity which uses the operation history and a usage form which is permitted or not permitted for the entity, and, in a case where the operator information included in the operation history registered by the registration unit satisfies the setting condition in the setting rule, performs setting so that the usage limitation information associated with the satisfied setting condition is used for usage limitation of the operation history of the document identified by the document identification information associated with the registered operation history.

2. The information processing apparatus according to claim 1,
wherein the registration unit further obtains, together with the operator information, an operation type indicating a type of the operation performed on the document by the operator, and registers, in the operation history memory, the operation history further including the obtained operation type in association with the document identification information,
wherein the setting condition in the setting rule further includes a condition regarding the operation type, and
wherein, in a case where the operator information and the operation type included in the registered operation history satisfy the setting condition, the setting unit performs setting so that the usage limitation information associated with the satisfied setting condition is used for usage limitation for the operation history of the document identified by the document identification information associated with the registered operation history.

3. The information processing apparatus according to claim 1,
wherein the setting unit further refers to a deletion rule memory that stores a deletion rule which is a predetermined deletion rule for deleting at least part of usage limitation information that is set to be used for usage limitation for the operation history and that associates a deletion condition regarding the operation history registered in the operation history memory with deletion target information indicating usage limitation information to be deleted, and, in a case where the operation history registered in the operation history memory satisfies the deletion condition, deletes the usage limitation information indicated by the deletion target information associated with the satisfied deletion condition from the usage limitation information that is set to be used for usage limitation of the operation history.

4. The information processing apparatus according to claim 2,
wherein the setting unit further refers to a deletion rule memory that stores a deletion rule which is a predetermined deletion rule for deleting at least part of usage limitation information that is set to be used for usage limitation for the operation history and that associates a deletion condition regarding the operation history registered in the operation history memory with deletion target information indicating usage limitation information to be deleted, and, in a case where the operation history registered in the operation history memory satisfies the deletion condition, deletes the usage limitation information indicated by the deletion target information associated with the satisfied deletion condition from the usage limitation information that is set to be used for usage limitation of the operation history.

5. The information processing apparatus according to claim 1,
wherein the setting unit further registers, in a setting result information memory, information indicating a type of a document to which the usage limitation information used for usage limitation for the operation history has been set, and, in a case where the type of the document identified by the document identification information associated with the registered operation history is the same as the type of document registered in the setting result information memory, performs setting so that at least part of the usage limitation information that has been set for the operation history of the document of the type is used for usage limitation of the operation history of the document identified by the document identification information associated with the registered operation history.

6. The information processing apparatus according to claim 2,
wherein the setting unit further registers, in a setting result information memory, information indicating a type of a document to which the usage limitation information used for usage limitation for the operation history has been set, and, in a case where the type of the document identified by the document identification information associated with the registered operation history is the same as the type of document registered in the setting result information memory, performs setting so that at least part of the usage limitation information that has been set for the operation history of the document of the type is used for usage limitation of the operation history of the document identified by the document identification information associated with the registered operation history.

7. The information processing apparatus according to claim 3,
wherein the setting unit further registers, in a setting result information memory, information indicating a type of a document to which the usage limitation information used for usage limitation for the operation history has been set, and, in a case where the type of the document identified by the document identification information associated with the registered operation history is the same as the type of document registered in the setting result information memory, performs setting so that at least part of the usage limitation information that has been set for the operation history of the document of the type is used for usage limitation of the operation history of the document identified by the document identification information associated with the registered operation history.

8. The information processing apparatus according to claim 4,
wherein the setting unit further registers, in a setting result information memory, information indicating a type of a document to which the usage limitation information used for usage limitation for the operation history has been set, and, in a case where the type of the document identified by the document identification information associated with the registered operation history is the same as the type of document registered in the setting result information memory, performs setting so that at least part of the usage limitation information that has been set for the operation history of the document of the type is used for usage limitation of the operation history of the document identified by the document identification information associated with the registered operation history.

9. The information processing apparatus according to claim 1,
wherein the setting unit performs setting so that the usage limitation information associated with the setting condition is used for usage limitation for the operation history that satisfies the setting condition.

10. The information processing apparatus according to claim 2,
wherein the setting unit performs setting so that the usage limitation information associated with the setting condition is used for usage limitation for the operation history that satisfies the setting condition.

11. An information processing method comprising:
registering in an operation history memory, when obtaining operator information indicating an operator who has performed an operation on a document, document identification information of the document and an operation history including the obtained operator information in association with each other; and
referring to a setting rule memory that stores a setting rule which is a predetermined rule for setting a usage limitation for the operation history and which associates a setting condition with usage limitation information, the setting condition including a condition regarding the operator information, the usage limitation information indicating a set of an entity which uses the operation history and a usage form which is permitted or not permitted for the entity, and, in a case where the operator information included in the registered operation history satisfies the setting condition in the setting rule, performing setting so that the usage limitation information associated with the satisfied setting condition is used for usage limitation of the operation history of the document identified by the document identification information associated with the registered operation history.

12. A non-transitory computer readable medium storing a program causing a computer to execute a process, the process comprising:
registering in an operation history memory, when obtaining operator information indicating an operator who has performed an operation on a document, document identification information of the document and an operation history including the obtained operator information in association with each other; and
referring to a setting rule memory that stores a setting rule which is a predetermined rule for setting a usage limitation for the operation history and which associates a setting condition with usage limitation information, the setting condition including a condition regarding the operator information, the usage limitation information indicating a set of an entity which uses the operation history and a usage form which is permitted or not permitted for the entity, and, in a case where the operator information included in the registered operation history satisfies the setting condition in the setting rule, performing setting so that the usage limitation information associated with the satisfied setting condition is used for usage limitation of the operation history of the document identified by the document identification information associated with the registered operation history.
